(19) United States
(12) Patent Application Publication
(10) Pub. No.: US 2013/0308682 A1
(43) Pub. Date: Nov. 21, 2013

(54) DISTRIBUTED AND DYNAMICAL BRILLOUIN SENSING IN OPTICAL FIBERS

(71) Applicants: Moshe Tur, Tel Aviv (IL); Yair Peled, Kfar Ruth (IL)

(72) Inventors: Moshe Tur, Tel Aviv (IL); Yair Peled, Kfar Ruth (IL)

(73) Assignee: Ramot at Tel Aviv University Ltd., Tel Aviv (IL)

(21) Appl. No.: 13/981,607

(22) PCT Filed: Jan. 26, 2012
(86) PCT No.: PCT/IB12/50362

§ 371 Date: Jul. 25, 2013

Related U.S. Application Data
(60) Provisional application No. 61/436,661, filed on Jan. 27, 2011.

(51) Int. Cl. G01K 11/32

(52) U.S. Cl. CPC G01K 11/32
USPC 374/161

(57) ABSTRACT

A method of distributed and dynamical Brillouin sensing in optical fibers is provided herein. The method includes the following stages: deriving average characteristics of an optical fiber along its length; generating a variable frequency probe signal, such that the variable frequency is tailored to match, at specified points along the fiber, the respective average characteristics; injecting the variable frequency probe signal to a first end of the optical fiber and a periodic pulse signal to a second end of the optical fiber, wherein the injecting is synchronized such that a stimulated Brillouin scattering is carried out at each one of the specified points along the optical fiber, such that a frequency difference between the probe signal and the pump signal matches the average characteristics of the fiber; and measuring occurrences of the stimulated Brillouin scattering, to yield data indicative of strain and temperature at all points along the optical fiber.

### BACKGROUND

1. Technical Field

The present invention relates to sensing Brillouin scattering in optical fibers and more particularly, to a distributed and dynamical Brillouin sensing.

2. Discussion of the Related Art

The use of stimulated Brillouin scattering (SBS) for fiber optic strain and temperature distributed sensors is well known in the art. One of the most widely used approaches is the classical method of Brillouin optical time-domain analysis technique (BOTDA), where a pump pulse interacts with a counter propagating probe wave. Strain and temperature information is deduced from the local Brillouin gain spectrum (BGS), which is measured by scanning the optical frequency of the probe wave.

To achieve high strain/temperature resolution over a wide dynamic range of these two measurands, the scanned frequency range must be wide (>100 MHz) and of high granularity, resulting in a fairly slow procedure, that often requires multiple scanning to reduce noise. Thus, classical BODTA is currently mainly applied to the average or semi-average measurements.

### BRIEF SUMMARY

The present invention, in embodiments thereof, provides a method of using stimulated Brillouin scattering (SBS), to achieve quasi-simultaneous distributed measurement of dynamic strain along an entire Brillouin-inhomogeneous optical fiber. Following classical mapping of the temporally slowly varying Brillouin gain spectrum (BGS) along the fiber, it will be shown below how to use a specially synthesized and adaptable probe wave to always work on the slope of the local BGS, allowing a single pump pulse to sample fast strain variations along the entire fiber. Strain vibrations on the order of KHz can be simultaneously sampled (i.e., using the same pump pulse) along the entire fiber length, having different average Brillouin shifts.

According to one aspect of the invention, the average characteristics of the fiber under test are first studied along its length. The average characteristics are then used to generate a variable frequency probe signal. The variation in the frequency is tailored based on the studied average characteristics. Additionally, the pump pulse wave and the tailored probe wave are synchronized such that in each specified location along the fiber, the stimulated Brillouin scattering is carried out in optimal conditions, i.e. within the desirable working point. This is achieved due to the match between the average characteristics in a specified location and the frequency of the probe signal in any point the stimulated Brillouin scattering is designed to be carried out.

According to another aspect of the invention, the average characteristics of the fiber under test are not studied prior to the dynamic interrogation of the stimulated Brillouin scattering. Alternatively, a periodic probe wave is generated with a plurality of even length sections, each associated with a different Brillouin shift frequency. The number of the different frequency sections used in the probe wave and their span determine the granularity and range of the strain/temperature that can be measured. The periodic pulse wave is synchronized such that each pump pulse wave meets a different frequency section of the probe wave as it (i.e., the pump wave) propagates along the fiber. For each fiber segment the best fitting probe frequency (in terms of the working point) is chosen, from which the measurement for this segment is taken.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a schematic diagram illustrating the variable probe signal and the pulse signal within the fiber at various periods of time, according to some embodiments of the invention;

FIG. 2 is a graph illustrating the Brillouin gain spectrum according to some embodiments of the invention;

FIG. 3 is a schematic diagram illustrating the variable probe signal and the pulse within the fiber according to some embodiments of the invention;

FIGS. 4A and 4B are high level flowcharts illustrating methods according to some embodiments of the invention;

FIG. 5 is a schematic block diagram illustrating an exemplary experimental system configured to carry out the methods according to some embodiments of the invention;

FIG. 6 is a schematic diagram illustrating an aspect according to some embodiments of the invention;

FIG. 7 is a schematic diagram illustrating the variable probe signal and the pulse within the fiber according to other embodiments of the invention;

FIG. 8 is a graph illustrating experimental results according to some embodiments of the invention;

FIG. 9 is a graph illustrating experimental results according to some embodiments of the invention; and

FIG. 10 is a graph illustrating experimental results according to some embodiments of the present invention.

### The drawings together with the following detailed description make apparent to those skilled in the art how the invention may be embodied in practice.

### DETAILED DESCRIPTION

The present invention, in embodiments thereof, suggests using a probe signal with variable frequency tailored to match average characteristics of an optical fiber under test. Under average strain/temperature conditions, the Brillouin gain spectrum of a uniform fiber is constant along the entire length of the fiber under test. For a given pump frequency, the optical frequency of the counter-propagating probe is then chosen to coincide with one of the −3 dB points of the ˜30 MHz-wide Lorentzian Brillouin gain spectrum. Alternatively, any other point along the slope may be chosen, possibly but not necessarily the center of the slope. It is understood that in the following description, any reference to a −3 dB point should be interpreted as a point along the slope.

In the presence of strain changes, the BGS shifts at approximately 50 MHz/1000 μS, and the fixed frequency probe wave will now experience less or more Brillouin gain, depending of the direction of the BGS shift. Each pump pulse gives rise to a Brillouin-amplified probe signal, whose post processing simultaneously provides the local strain along the entire fiber. Since the probe frequency is not swept, the sampling rate of the strain changes is limited only by the fiber length and the need for averaging. When done digitally, the measurements ends with a two dimensional matrix, where each row represents one time slot containing the probe intensity, resulting from a single pump pulse, and the number of columns is the number of spatial resolution cells along the fiber. Since the fixed probe frequency must remain within the ˜30 MHz wide BGS slope, the dynamic range of this approach is limited to ˜600 με, unless means are taken (e.g., shorter pump pulses) to decrease the BGS slope, at the expense of sensitivity. Normally, though, the center of the BGS varies along the fiber due to either fiber non-uniformity or to the non-uniform average strain/temperature to which the fiber is exposed.

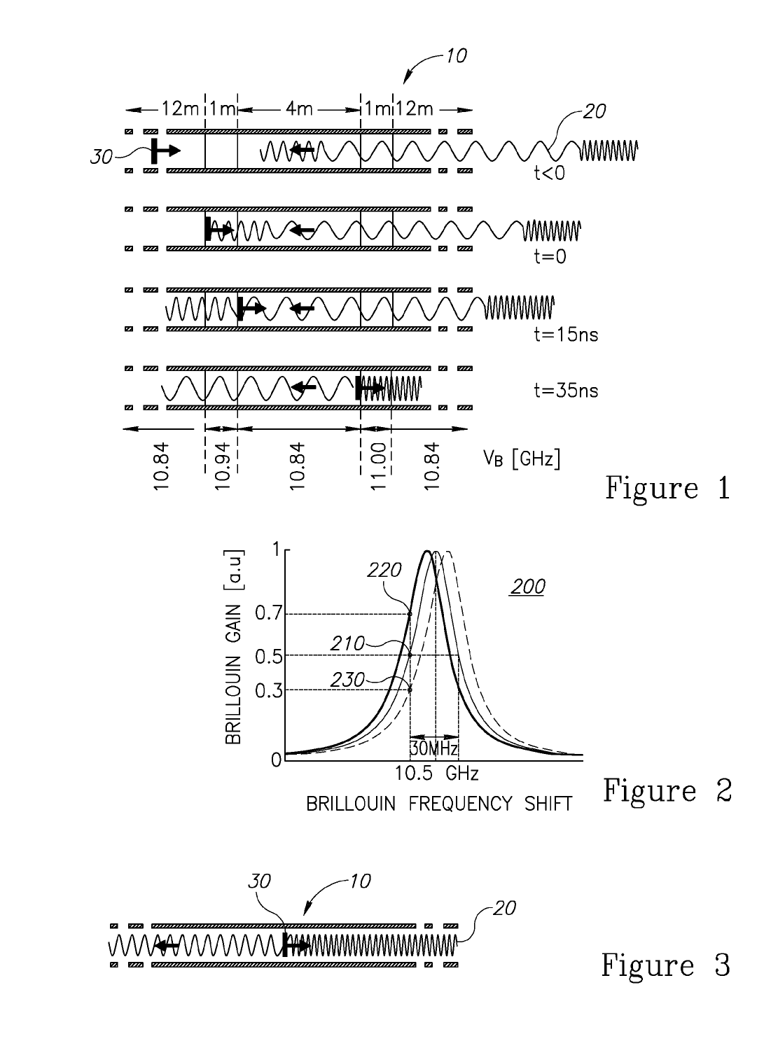

FIG. 1 is a schematic diagram illustrating the variable probe signal and the pulse signal within the fiber at various periods of time, according to some embodiments of the invention. Fiber under test 10 is, in a non limiting example, a 30 m long optical fiber with five different fiber sections, with ν_{3dB}(z) of 10.81 GHz for first 12 m, middle 4 m and last 12 m sections, 10.91 GHz for the left lm section and 10.97 GHz for the right 1 m section. The optical frequency of the probe signal 20 is tailored to start with a 24 m (while propagating in the fiber) segment of optical frequency of, ν_{probe,3dB}(z)=νₚᵤₘₚ−10.81 GHz, followed by a 2 m segment of frequency ν_{probe,3dB}(z)=νₚᵤₘₚ−10.91 GHz, 8 m of νₚᵤₘₚ−10.81 GHz, 2 m of νₚᵤₘₚ−10.97 GHz and ending with a 24 m segment of frequency νₚᵤₘₚ−10.81 GHz. Thus, for each fiber section, having a average Brillouin shift of ν_{3dB} (section) and length L_{section}, the probe signal 20 has a corresponding segment, twice as long, with an optical frequency of νₚᵤₘₚ−ν_{3dB}(section). Proper timing synchronization between the pump pulse 30 and the tailored probe wave 20 ensures that in each fiber section the probe frequency precisely coincides with the appropriate point along the slope of the average BGS at that section. Under these conditions, it would be easily possible to measure fast strain variations, as described above. Slow temporal variations of ν_{3dB}(z) can be tracked by evaluating the average of the intensity fluctuations coming from distance z, and using this average as a feedback signal, the frequency composition of the probe wave can be appropriately readjusted. Another way to follow slow temporal variations of ν_{3dB}(z) is to execute classical BOTODA measurements once in a while, or from time to time.

Slow temporal variations of ν_{3dB}(z) can be also tracked effectively by tracking the peak of the BGS by various methods known in the art and used for other applications. An exemplary method would be generating and sensing dithering probe signals with frequencies evenly spaced from the known peak of the BGS.

FIG. 2 is a graph illustrating the Brillouin gain spectrum 200 according to some embodiments of the invention. A working point 210 at half gain (or at the optimal point which gives maximal linear dynamic range and/or maximal sensitivity) is used for working on the slope of the Lorentzian with points 220 and 230 indicating the temporal reduced strain and the temporal increased strain respectively. Consistent with embodiments of the invention, starting with a classical mapping of the Brillouin shift along the fiber to determine one of the two −3 dB points of the local Brillouin gain spectrum: ν_{B,3dB}(z), it is then possible to temporally tailor the probe frequency so that when the pump pulse arrives at fiber location z it meets a probe wave, whose frequency is exactly ν_{B,3dB}(z) away from the pump frequency, ensuring good Brillouin interaction. Using this technique the whole length of the fiber can be interrogated with a single pulse, or a few, if integration is required.

For practical reasons, embodiments of the present invention provide a method based on the tailoring of the probe frequency to match the average strain/temperature conditions at each spatial segment of fiber 10. For a given pump frequency classical BOTDA is first used to map the peak frequency of the local BGS along the fiber length, from which the distance-dependent probe frequency is obtained, ν_{probe,3dB}(z)=νₚᵤₘₚ−ν_{3dB}(z), which coincides with one of the −3 dB points on the BGS at distance z (ν_{3dB}(z) is the local Brillouin shift from the pump frequency, νₚᵤₘₚ, to the probe frequency ν_{probe,3dB}(z)).

FIG. 3 is a schematic diagram illustrating the variable probe signal and the pulse within the fiber according to some embodiments of the invention. The diagram illustrates a simpler experimental probe wave 20 having two frequencies at the moment when it meets the pump pulse 30 at the middle of the 4 m section of fiber 10. An experimental system and results are described in detail below.

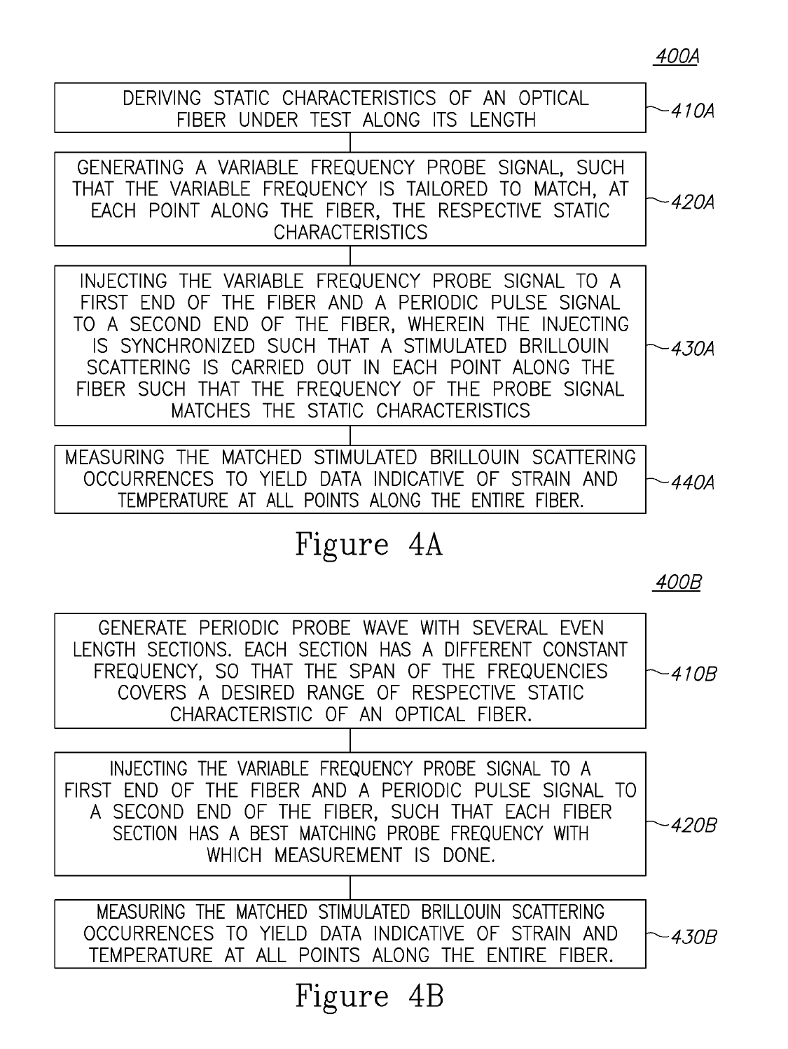

FIG. 4A is high level flowchart illustrating one method according to some embodiments of the invention. Method 400A includes the following stages: deriving average characteristics of an optical fiber under test along its length 410A; generating a variable frequency probe signal, such that the variable frequency is tailored to match, at each point along the fiber, the respective average characteristics 420A; injecting the variable frequency probe signal to a first end of the fiber and a periodic pulse signal to a second end of the fiber, wherein the injecting is synchronized such that a stimulated Brillouin scattering is carried out in each point along the fiber such that the frequency of the probe signal matches the average characteristics 430A; and measuring the stimulated Brillouin scattering occurrences to yield data indicative of strain and temperature at all points along the entire fiber 440A.

FIG. 4B is high level flowchart illustrating another method according to some embodiments of the invention. Method 400B includes the following stages:

generating a periodic variable frequency probe signal, wherein the probe signal exhibits a plurality of temporal sections, each of which is associated with a different frequency selected to cover a dynamic range of respective average characteristic of an optical fiber 410B; injecting the variable frequency probe signal to a first end of the fiber and a periodic pulse signal to a second end of the fiber, such that each fiber section has a best matching probe frequency with which measurement is done 420B; and measuring the matched stimulated Brillouin scattering occurrences to yield data indicative of strain and temperature at various points along the fiber 430B.

The remainder of the description describes an exemplary system configured to implement methods consistent with embodiments of the present invention. It is understood that values and numbers provided herein are for illustrative purposes only and should not be regarded as limiting in scope.

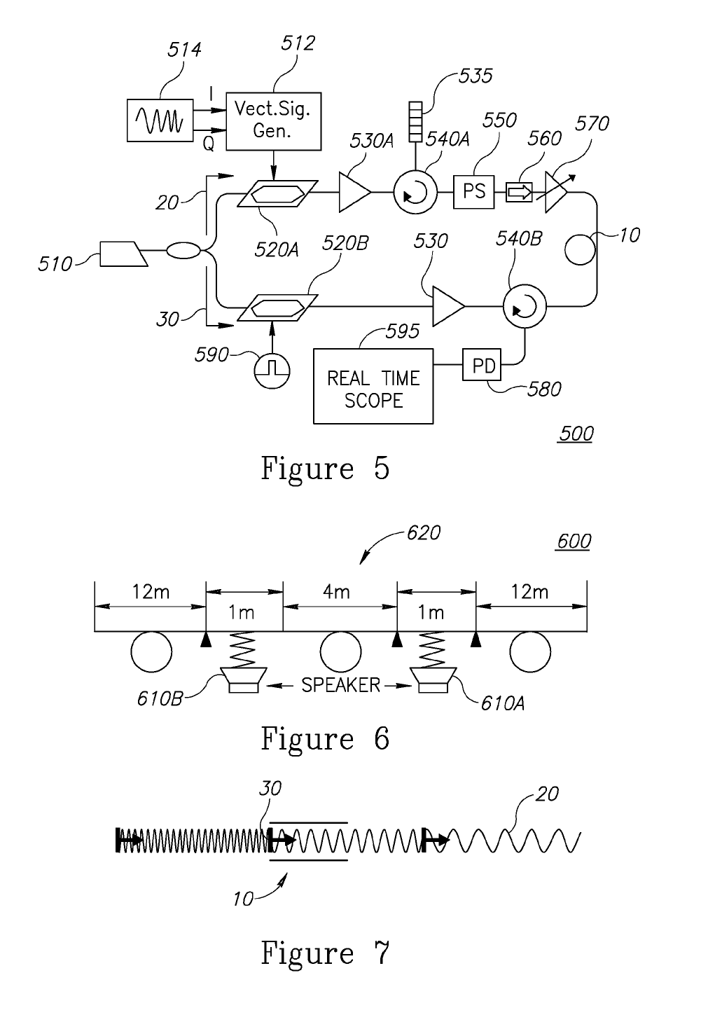

FIG. 5 is a schematic block diagram illustrating an exemplary experimental system configured to carry out the methods according to some embodiments of the invention. A narrow line-width (10 KHz) DFB laser diode 510, is split into pump 30 and probe 20 channels. A ˜11 GHz RF signal 512, to be described below, feeds the probe channel Mach-Zehnder modulator 520A, which is biased at its zero transmission point to generate two sidebands. Using a narrow fiber Bragg grating 535 and circulator 540A the lower frequency sideband is selected to be the probe. This probe wave 20 is then amplified by an Erbium doped fiber amplifier 530A, optionally scrambled by a polarization scrambler 550 and launched into one side of the 30m fiber under test 10. Modulator 520B forms the pump pulse 30, which is then amplified by amplifier 530 and launched into the other side of fiber 10 through a circulator 540B. The Brillouin-amplified probe wave is finally routed by 540B to a fast photodiode 580 sampled at 1 GSamples/sec by a real-time oscilloscope 595.

In an experiment carried out, the Applicants have demonstrated the distributed measurement of two concatenated 1 m sections, made of the same fiber, experiencing the same average strain of ˜1000 με, and vibrating at different frequencies of 55 Hz and 470 Hz. FIG. 6 shows an arrangement used in the experiment carried out by the Applicants using sine-waves fed audio speakers 610A and 610B. In this variation, 520A was fed by an RF sine wave to adjust the probe frequency to coincide with the −3 dB point of the Brillouin gain spectrum, which was the same for the two sections. 15 ns wide pump pulses were used at a repetition rate of 3.33 MHz, resulting in 300 recorded samples of the intensity of the Brillouin-amplified probe wave for each pump pulse. The sampled data were arranged in a matrix of N rows by M columns, where M is the number of oscilloscope samples per pump pulse (=300), and N is the number of pump pulse cycles used in the measurement.

FIG. 7 is a schematic diagram illustrating the variable probe signal and the pulse within the fiber according to other embodiments of the invention. Consistent with aforementioned method 400B probe signal 20 may be constructed from a plurality of segments of constant frequencies. The period of each segment is equal to one round trip time of the pump pulse in the fiber under test. The frequency difference between two adjacent frequencies is less than the Brillouin gain Lorentzian bandwidth, enabling this comb of frequencies to cover the desired dynamic range of strain/temperature with the planned frequency resolution. When analyzing the measurements, a simple algorithm will be used to find for each fiber segment the probe frequency which is the closest to the −3 dB Lorentzian frequency spectrum, and use its measurements for this specific segment. The closer the optimal frequency to the −3 dB point, the wider the achievable dynamic range becomes. The more frequencies used, the wider the strain range which will be covered and the finer will the frequency resolution be. There is a clear trade-off between the number of frequency segments and the measuring maximum sampling rate.

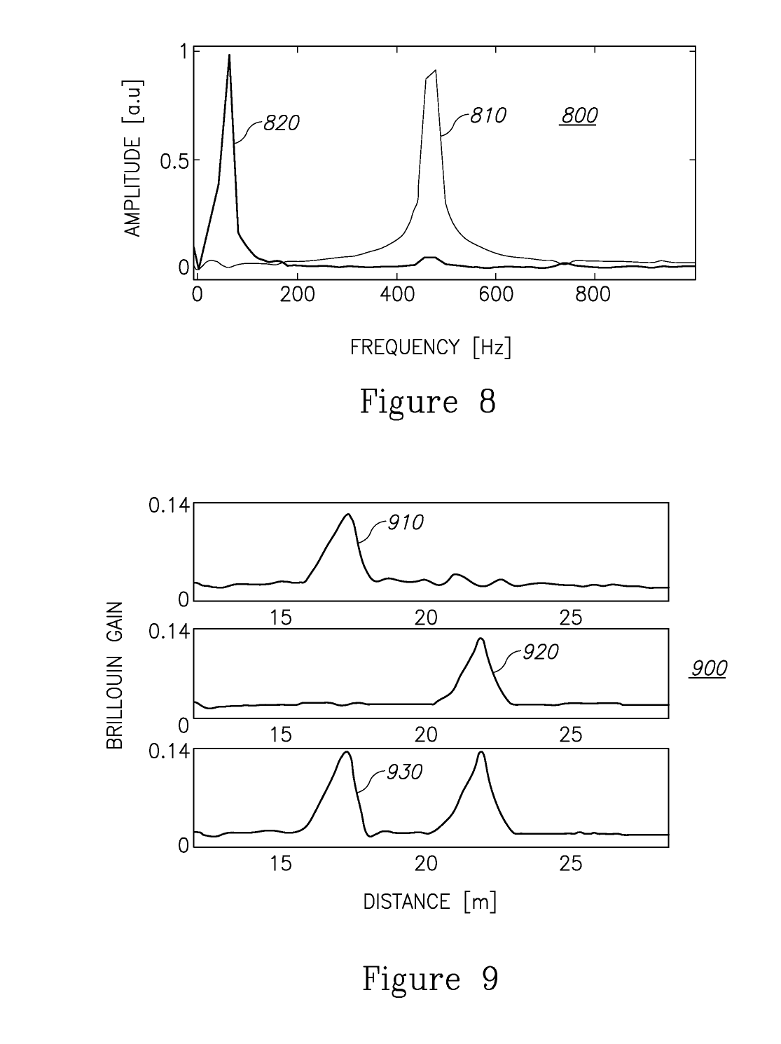

FIG. 8 presents the Fourier transform of typical columns of the above mentioned matrix in the first and second sections, respectively, clearly showing the two vibration frequencies. Vibration frequencies up to 2 KHz were easily measured. Thus, each row of the matrix contains information about the different spatial resolutions cells along the fiber while each column contains the time history of a single such cell.

In order to emulate a fiber with a z-dependent Brillouin shift, a fiber comprising five fiber sections was used. The configuration used was the following: The 4 m section and both 12 m sections were loose, while both lm sections could be statically and independently strained to adjust their respective Brillouin shifts. These strained sections were again coupled to the sine-waves-fed audio speakers to induce fast strain variations. Using the classical BOTDA technique with a 15 ns pump pulse, an RF sine wave was scanned at the input of 520A and found the peak of the BGS of the loose sections to be down-shifted from the pump frequency by 10.84 GHz, while the corresponding peaks of the two strained sections were down-shifted by 10.94 GHz and 11 GHz, with their −3 dB points lying at 10.91 GHz and 10.97 GHz, respectively. In order to create the complex, time-dependent probe frequency, a wideband, two-channel arbitrary waveform generator was used, which fed a microwave vector signal generator through the latter I/Q inputs. To apply the suggested method to fiber 10 described above, the I channel of the AWG 514 was programmed to emit an 800 ns sine-wave of 0.04 GHz, immediately followed by an 800 ns, 0.1 GHz sine-wave. With the Q channel comprising the Hilbert transform of the I channel, the frequency of the signal generator was set to 10.87 GHz to generate an RF input to 520A of 800 ns at 10.91 GHz (=10.87+0.04), followed by an 800 ns at 10.97 GHz (=10.87+0.1) burst.

Returning now to the experiment described above, FIG. 9 is a graph illustrating the experimental results according to the experimental system of FIG. 5. The graph 900 shows the measured Brillouin gain along the five sections fiber for three different probe waves. Graph 910 shows a uniform frequency shift of 10.91 GHz, matching only the leftmost 1 m section. Graph 920 shows a uniform frequency shift of 10.97 GHz, matching only the rightmost 1 m section. Graph 930 shows the complex waveform of probe 20 in FIG. 3 matching both sections. Clearly, the complex probe wave allows a single pump pulse to simultaneously measure and locate two Brillouin-different fiber segments. The observed spatial resolution is limited by the 15 ns pump pulse. Using the complex probe wave, and applying 60 Hz to the left 1 m section and 100 Hz to the right 1 m sections, the induced vibrations could be simultaneously recorded.

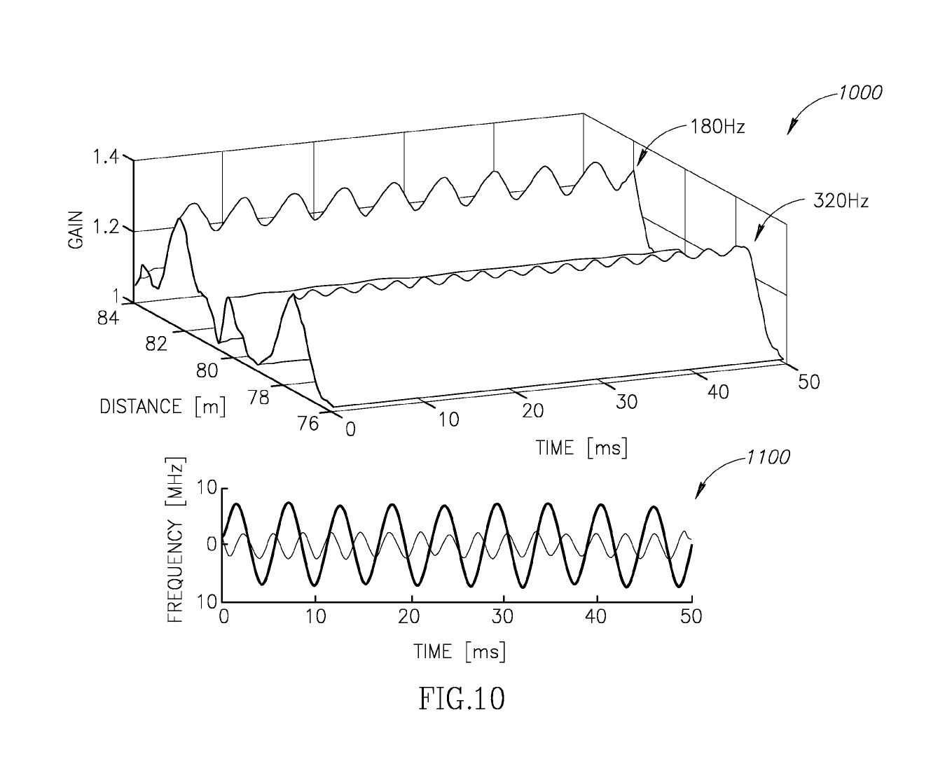

FIG. 10 is a graph illustrating experimental results according to some embodiments of the present invention. Generally, FIG. 10 presents measured vibrations as a function of time along a 10 meter section of an 85 meter long fiber under test. Specifically, FIG. 10 depicts two graphs 1000 and 1100 illustrating the experimental results according to the experimental system of FIG. 5. Hence, graph 1000 illustrates strain-induced gain vibrations at 150 Hz and 400 Hz, respectively as measured, for example, at two 1 meter fibber sections, when adjusted to have a different average Brillouin frequency shifts (BFS). The aforementioned gain vibrations can be obtained utilizing the speakers, for example speakers 610A and 610B. Graph 1100 illustrates corresponding time sequence from two columns of the above mentioned M×N matrix, corresponding to the centers of a first section and a second section of the fiber under test. Graphs 1000 and 1100 illustrate the measurements after signals have gone through 1 Khz low pass filter.

Other aspects of the invention include constructing several adapted probe waves, each one fits a different point of the distributed BGS. In this case, each pump pulse can interact with a different complex probe wave, enabling the fast interrogation of the BGS distribution along a fiber under test, such as the fiber 10. Thus, instead of working with a single complex probe wave adapted to match only one of the −3 dB point of the distributed BGS (as described above), it is possible to choose, for example, to monitor 3 points on the BGS, for example, two −3 dB points (or center of slope) of the BGS (one on each side), as well as the peak of the BGS. In order to perform such measurements, for example, three different adapted probe waves can be constructed to match the three different BGS pointes. Each pump pulse will meet a different complex probe wave, thereby fitting one of the aforementioned three points. Eventually, in such an implementation, the entire length of the fiber 10 can be interrogated at the three BGS points in a relatively very short time during every three sequential pump pulses. Utilizing the present technique, a fast tracking of the varying distributed BGS along the fiber can be achieved.

While the invention has been described with respect to a limited number of embodiments, these should not be construed as limitations on the scope of the invention, but rather as exemplifications of some of the preferred embodiments. Other possible variations, modifications, and applications are also within the scope of the invention.

What is claimed is:

1. A method comprising:
deriving average characteristics of an optical fiber under test along its length;
generating a variable frequency probe signal, such that the variable frequency is tailored to match, at specified point along the optical fiber, the respective average characteristics;
injecting the variable frequency probe signal to a first end of the optical fiber and a periodic pulse signal to a second end of the optical fiber, wherein the injecting is synchronized such that a stimulated Brillouin scattering is carried out at each one of the specified points along the optical fiber, such that the frequency difference between the probe signal and the pump signal matches the average characteristics of the fiber; and
measuring occurrences of the stimulated Brillouin scattering, to yield data indicative of strain and temperature at all points along the entire optical fiber.

2. The method of claim 1, wherein the average characteristics of the optical fiber relate to the uneven strain along an entire Brillioun-inhomogeneous optical fiber.

3. The method of claim 1, wherein for each fiber section, having a average Brillouin shift, characterized by a first frequency and a first segment length, the probe signal has a corresponding characteristic second frequency and second segment length.

4. The method of claim 3, wherein each frequency segment of the probe wave is chosen to coincide with a predetermined point along a slope of the Lorentzian Brillouin gain spectrum of the corresponding segment.

5. The method of claim 1, further comprising tracking the average characteristics of the optical fiber over time and readjusting frequency composition of the variable frequency probe signal, to yield a better synchronization in the injection, in a case of slowly varying average characteristics of the optical fiber.

6. The method of claim 1, further comprising evaluating an average of intensity fluctuations coming from distance z, and using the average as a feedback signal, so that frequency composition of the variable frequency probe signal are appropriately readjusted, to yield a better synchronization in the injection, in a case of slowly varying average characteristics of the optical fiber.

7. The method of claim 1, further comprising tracking a peak of the Brillioun gain spectrum by generating and sensing a dithering probe signal, to yield a better synchronization in the injection, in a case of slowly varying average characteristics of the optical fiber.

8. The method of claim 1, further comprising repeatedly executing at specified points of time, classical BOTODA measurements, to yield a better synchronization in the injection, in a case of slowly varying average characteristics of the optical fiber.

9. The method of claim 1, wherein in the generating, a plurality of different tailored probe signals are produced, such that each tailored probe signal matches a different points on the non-uniformly distributed BGS Lorentzian, and wherein in the injecting, the plurality of different tailored probe signals are injected to the first end of the optical fiber and the periodic pulse signal is injected to the second end of the optical fiber, wherein the injecting is synchronized such that each tailored probe wave meets a different pump pulse, obtaining the measurements from one specified point on the BGS Lorentzian.

10. A system comprising:
means for deriving average characteristics of an optical fiber under test along its length;
a first optical source configured to generate a variable frequency probe signal, such that the variable frequency is tailored to match, at specified point along the optical fiber, the respective average characteristics;
a second optical source configured to generate a periodic pulse signal;
means for injecting the variable frequency probe signal to a first end of the optical fiber and a periodic pulse signal to a second end of the optical fiber, wherein the injecting is synchronized such that a stimulated Brillouin scattering is carried out at each one of the specified points along the optical fiber, such that the frequency difference between the probe signal and the pump signal matches the average characteristics of the fiber; and
a measuring device configured to measure occurrences of the stimulated Brillouin scattering, to yield data indicative of strain and temperature at all points along the entire optical fiber.

11. The system of claim 10, wherein the average characteristics of the optical fiber relate to the average strain/temperature distributed along an entire Brillouin-inhomogeneous optical fiber.

12. The system of claim 10, wherein for each fiber section, having an average Brillouin shift, characterized by a first frequency and a first segment length, the probe signal has a corresponding characteristic second frequency and second segment length.

13. The system of claim 10, wherein each frequency segment of the probe wave is chosen to coincide with a predetermined point along a slope of the Lorentzian Brillouin gain spectrum of the corresponding segment.

14. The system of claim 10, further comprising means for evaluating an average of intensity fluctuations coming from distance z, and using the average as a feedback signal, so that frequency composition of the variable frequency probe signal are appropriately readjusted, to yield a better agreement in the injection, in a case of a slowly varying average characteristics of an optical fiber under test.

15. The system of claim 10, further comprising means for repeatedly executing at specified points of time, classical BOTDA measurements, so that frequency composition of the variable frequency probe signal are appropriately readjusted, to yield a better agreement in the injection, in a case of slowly varying average characteristics of the optical fiber under test.

16. A method comprising:
generating a periodic probe wave with a one or plurality of even length sections, each associated with a different Brillouin shift frequency to cover a frequency range of Brillouin properties of an optical fiber; wherein each pump pulse is synchronized to meet one segment of a constant probe frequency that is different from the other segments;
injecting the variable frequency probe signal to a first end of the optical fiber and a periodic pulse signal to a second end of the optical fiber, such that each fiber section has a best matching probe frequency that best matches a Brillouin gain spectrum slope center of the fiber; and
measuring the matched stimulated Brillouin scattering occurrences, to yield data indicative of strain and temperature at all points along the entire optical fiber.

17. A system, comprising:
a first optical source configured to generate a variable frequency probe signal, such that the variable frequency is tailored to match, at each point along the optical fiber, respective average characteristics of the fiber;
a second optical source configured to generate a periodic pulse signal;
means for injecting the variable frequency probe signal to a first end of the optical fiber and the periodic pulse signal to a second end of the optical fiber, wherein the injecting is synchronized such that a stimulated Brillouin scattering is carried out in each point along the optical fiber such that the frequency difference between the probe signal and the pump signal matches the average characteristics of the fiber; and
a measurement device configured to measure the stimulated Brillouin scattering occurrences, to yield data indicative of an uneven strain and temperature at all points along the entire optical fiber.

18. A method comprising:
deriving average characteristics of an optical fiber under test along its length;
generating a variable frequency probe signal, such that the variable frequency probe signal exhibits different frequencies along different points along the optical fiber for any given point of time;
injecting the variable frequency probe signal to a first end of the optical fiber and a periodic pulse signal to a second end of the optical fiber, wherein the injecting is synchronized such that a stimulated Brillouin scattering is carried out at each one of the specified points along the optical fiber, such that the frequency difference between the probe signal and the pump signal matches the average characteristics of the fiber; and
measuring occurrences of the stimulated Brillouin scattering, to yield data indicative of strain and temperature at all points along the entire optical fiber.
